(19) United States
(12) Patent Application Publication
(10) Pub. No.: US 2009/0166361 A1
(43) Pub. Date: Jul. 2, 2009

(54) TWO-PART, FLIP TOP, SNAP CAP FOR VIALS

(75) Inventor: Armindo Lourenco, Noyelles-Godault (FR)

Correspondence Address: SCOTT R. COX;LYNCH, COX, GILMAN & MAHAN, P.S.C., 500 WEST JEFFERSON STREET, SUITE 2100, LOUISVILLE, KY, 40202, US

(73) Assignee: AIRSEC, Choisy le Roi (FR)

(21) Appl. No.: 12/042,779

(22) Filed: Mar. 5, 2008

Related U.S. Application Data
(63) Continuation-in-part of application No. 29/299,607, filed on Dec. 29, 2007.

(51) Int. Cl. B65D 17/32; B65D 43/16; B01L 3/00

(52) U.S. Cl. 220/268; 220/810; 422/102

(57) ABSTRACT

A vial comprising a tube with upward extending lip and two-part, flip top, snap cap containing a top part comprising a circular top surface with a cylindrical outer wall, a cylindrical inner skirt and a desiccant chamber, wherein the top part further includes an inset portion formed in an outer surface of the cylindrical outer wall, and a tamper evident ring part joined to the top part by a hinge, wherein the tamper evident ring part further includes an inset portion that aligns with the inset portion of the top part when the cap is closed and breakable tabs joining the top part to the ring part.

### RELATED APPLICATION

This application claims priority from application Ser. No. 29/299,607, filed on Dec. 29, 2007.

### BACKGROUND OF INVENTION

One embodiment of the invention relates to containers, particularly vials, which consist of a tube with a cap attached thereto. More particularly, another embodiment of the invention relates to a two-part, flip top, snap cap for attachment to a tube of a molded plastic vial, wherein the two-part cap contains a circular top part and a tamper evident ring part with a gap therebetween, and further includes a hinge which joins the top part to the ring part. One embodiment of the invention is the structure of this two-part, flip top, snap cap for tubes, wherein each of the two parts of the cap includes an inset portion, which inset portions eliminate the need for a thumb tab or beak extending outward away from the outer surface of the cap to assist in opening of the cap.

A number of molded tube and cap assemblies have been produced in which the cap is seated onto the tube of the vial when in a closed position. Some tube and cap assemblies also include tamper evident elements, whereby upon inspection thereof, the consumer can determine whether the vial has been opened.

The cap for these prior art containers or vials generally includes a thumb tab or beak extending away from the outer surface of the vial which is designed to be used for the opening of the container. However, the presence of this thumb tab or beak increases the size of the packaging necessary for the container and also increases the costs of manufacture of the container.

Therefore, it is one object of an embodiment in the invention to provide an improved two-part, flip top, snap cap which are joined with tubes to form vials which are particularly designed for the storage of pharmaceutical or neutraceutical products.

It is another object of one embodiment of the invention to provide a two-part, flip top, snap cap for tubes which is joined to a tube to form a vial, which cap contains a top part and a tamper evident ring part with a gap therebetween, which parts are joined together to form the cap, which cap is attached on the tube to form the vial.

It is a further object of one embodiment of the invention to provide a two-part, flip top, snap cap for use with a tube to form a vial, which cap does not utilized a thumb tab or beak which extends outward from the outer surface of the cap, thereby making packaging of the vial and production of the cap easier.

These and other objects and features of one embodiment of the invention will become apparent to those skilled in the art from a consideration of the following detailed description, drawings and claims. However, the description, along with the accompanying drawings and claims, provides only a selected example of the construction of the product to illustrate one embodiment of the invention and does not place any limitations on the scope of the invention.

### SUMMARY OF INVENTION

In accordance with the present invention there is provided a two-part, flip top, snap cap (30) for tubes (20) comprising a top part (40), comprising a circular top surface (42) with a perpendicular, cylindrical, outer wall (50), a perpendicular, cylindrical, inner skirt (60), containing an outer sealing surface (64), a desiccant chamber (70) and an inset portion (54) formed into the outer surface (52) of the cylindrical outer wall (50); a tamper evident ring part (80) joined to the top part (40) by a hinge (90), wherein the ring part (80) further comprises an inset portion (86), formed in an outer surface (82) of the ring part (80), that aligns with the inset portion (54) of the top part (40) when the cap is closed; and breakable tabs (56) joining the top part (40) to the ring part (80), when the cap (30) is first joined to the tube (20), wherein when the breakable tabs (56) are broken, a continuous gap (88) is formed between the top part (40) and the ring part (80) around the cap, except for the hinge (90).

In a further embodiment of the invention, the top surface (42) of the top part (40) further comprises a parabolic-shaped inset portion (44) that is aligned with the inset portion (54) of the top surface (42) to form a “false lip” for the cap (30).

In a further embodiment of the invention, the cap (40) does not further comprise a beak or thumb tab extending outward from the outer surface (52) of the cylindrical outer wall (50) of the top part (40).

In a further embodiment of the invention, there is provided a vial (10) comprising a tube (20) with upward extending lip (22) and the two-part, flip top, snap cap (30) described above, that is secured to the upward extending lip (22) of the tube (20).

### BRIEF DESCRIPTION OF THE DRAWING

Various embodiments of the invention will now be described with reference to the accompanying drawings in which:

FIG. 1 is a side perspective view of the vial with cap secured onto the tube with the cap in a closed position showing the hinge of the cap.

FIG. 2 is a perspective view of the vial of FIG. 1 rotated 90° showing the inset portions of the cap.

FIG. 3 is a cut away side view of the vial of FIG. 1.

FIG. 4 is a side perspective view of the vial of FIG. 2 with the top portion of the cap rotated to an open position about the hinge after breakable tabs are broken.

FIG. 5 is a view of the cap on the tube after it has been opened.

### DETAILED DESCRIPTION OF A PREFERRED EMBODIMENT

Although the invention is adaptable to a wide variety of uses and encompasses a significant number of embodiments, one preferred embodiment of the invention is shown in the drawings for purposes of illustration. This embodiment discloses a vial (10), as shown in FIGS. 1-4. The vial can contain a variety of products and is particularly useful for holding pharmaceutical or neutraceutical products.

The vial (10) comprises a tube (20) and a cap (30), which is secured onto the tube, to form the vial as shown in FIGS. 1-4. All components of the vial can be produced from conventional polymeric materials.

The tube (20) is a conventional cylindrical element with an open top containing an upwardly extending lip (22) to which the cap (30) is secured.

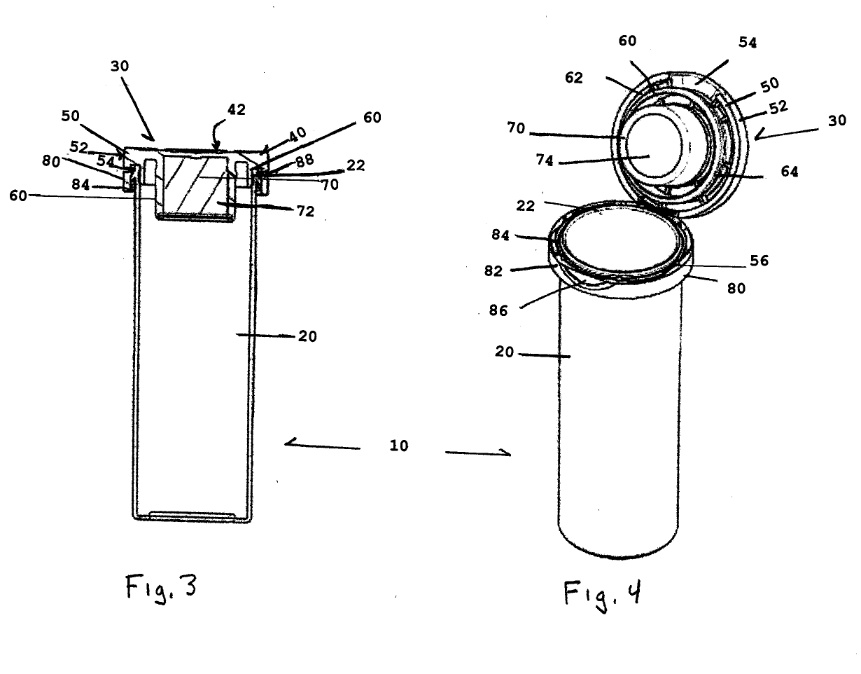

The cap (30) is a two-part, flip top, snap cap for securing onto the tube and is comprised of a top part (40), which has the appearance of a “false” cap, and a ring part (80), which cap is secured onto the tube forming a gap (88) between the two parts, as shown in FIG. 3.

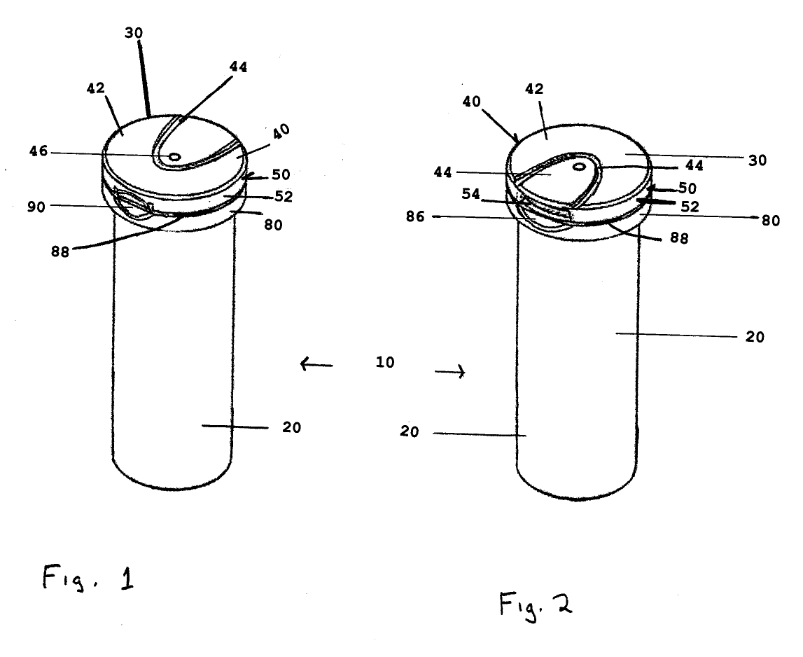

The top part (40) includes a circular, generally smooth top surface (42), which preferably contains an indentation into the surface thereof, preferably a parabolic-shaped insert (44), as shown in FIGS. 1 and 2. Near the center of the top surface (42) is preferably an injection mark (46), which is produced during the injection molding of the cap (30).

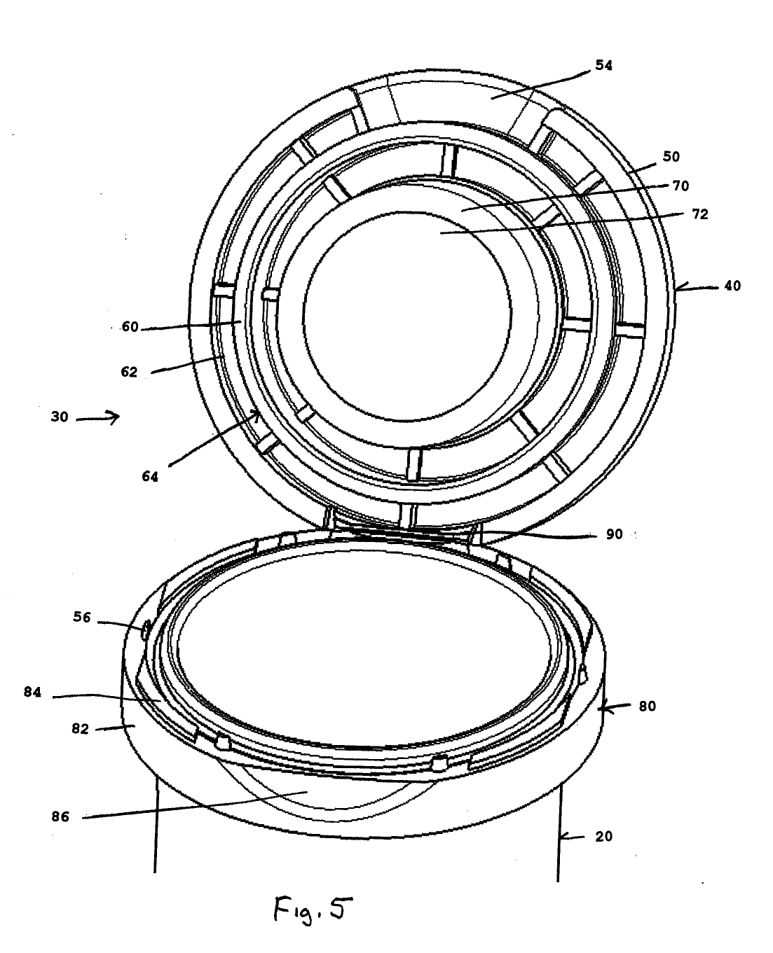

The top part (40) further includes a perpendicular, cylindrical outer wall (50) with an outer surface (52) thereon, as shown in FIGS. 3, 4 and 5. Present in the outer surface (52) is an inset portion (54), which is inset a sufficient distance to form a lip in the outer surface (52) of the cylindrical outer wall (50) of the cap, as shown in FIGS. 2 and 4. This inset (54) is used by an individual for opening the top part (40) of the cap. In one preferred embodiment the parabolic inset (44) lines up with the sides of the inset (54) in the outer wall (50), as shown in FIG. 2, thereby giving the illusion of a lip for the cap, thus form a “false lip”, which assists the consumer in opening the vial. On the lower edge of the cylindrical outer wall (50) are ends of breakable tabs (56) which secure the top part (40) to the ring part (80) of the cap (30) until the breakable tabs (56) are broken. Other than the breakable tabs (56) and the hinge (90), a continuous gap (88) is present between the top part (40) and the ring part (80) of the cap (30).

A perpendicular, cylindrical, inner skirt (60) also extends from the bottom surface of the top part (40) within the cylindrical outer wall (50), as shown in FIGS. 3, 4 and 5. Between the inner skirt (60) and the outer cylindrical wall (50), an outer gap (62) is formed. The top edge of the tube (20) may extend into this outer gap (62) when the cap is secured onto the tube. This inner skirt (60) has an outer wall which forms a sealing surface (64) which preferably forms a seal against the inner surface of the tube (20) when the cap is secured on the tube, thereby forming a leak proof seal. This sealing surface (64) protects any products present in the vial (10) against exposure to environmental contaminants and is preferably air tight. This inner skirt (60) forms one side of the gap of the ring part (80) with the ring part forming the other side thereof.

In a preferred embodiment, the top part (40) of the cap (30) also includes a perpendicular, desiccant chamber (70), which is formed to hold a desiccant material (72). This desiccant chamber (70) is located within the inner skirt (60), as shown in FIGS. 3, 4 and 5. The desiccant material can be any conventional desiccant product, which is designed to absorb moisture that is present within the vial (10) while the cap (30) is closed on the tube (20).

A second portion of the cap (30) is the ring part (80). The ring part is designed as a tamper evident portion, which is joined to the top part (40), as shown in FIG. 3. The top part (40) and the ring part (80) are joined by the hinge (90), which can be any conventional form of hinge. In addition, the ring part preferably contains inward facing tabs (84) which extend inward from the inner surface of the ring part and are secured against the outer surface of the top lip of the tube when the cap is closed. These inward facing tabs (84) assist in securing the cap (30) onto the tube (20).

The top surface of the ring part also contains ends of the breakable tabs (56) which join the top part (40) of the cap to the ring part (80). Thus, when the cap is first placed on the tube, the breakable tabs (56) secure the top part (40) to the ring part (80). However, when the top part (40) is rotated away from the ring part (80), around the hinge (90), these breakable tabs (56) break apart thereby permitting the cap to be opened, as shown in FIGS. 4 and 5.

Present in the outer surface (82) of the ring part is an inset portion (86) which aligns with the inset portion (54) which is present in the cylindrical outer wall of the top part. This inset portion (86) assists in the opening of the top part (40) by forming a thumb gap to assist in forcing the top part (40) to rotate away from the ring part (80) around the hinge (90). By use of the insert portions (54, 86), it is easy for a person to open the cap of the vial by rotation of the top part away from the ring part around the hinge (90). Further, by this arrangement of the components of the cap, it is not necessary that there be any thumb tab or beak that extends away from the surface of the cap, as is present in prior art vials. Thus, in a preferred embodiment there is no extending thumb tab or beak that extends away from the outer surface (52) of the cap.

There is a gap (62) between the inner surface of the ring part (80) and the outer surface of the inner skirt (60) of the top part. Into this gap is fitted the top edge of the tube. The inward facing tabs (84) assist in securing the cap (30) to the tube (20). Further, by this arrangement of elements, the inner skirt (60) forms a tight fit with the top edge of the tube.

The completed vial (10) is produced by securing the cap (30) onto the tube (20). The tube and cap can be formed by a conventional injection molding procedures. It is important that the cap be placed securely onto the tube with the top edge of the tube (20) forming a tight seal with the inner skirt (60) of the top part (40) of the cap (30). When the cap (30) is first secured onto the tube (20) before opening, a gap (88) exists between the top part (40) and the ring part of the cap (30) except where the two parts are joined by the breakable tabs (56) and the hinge (90). For the consumer to open the cap (30) of the vial (10), he merely presses upward on the inset (54) in the top part (40), breaks the breakable tabs (56) and rotates the top part (40) around the hinge (90) thereby providing access to the inside of the tube (20) of the vial (10), as shown in FIGS. 4 and 5.

It will thus be seen that the object set forth above, among those made apparent from the preceding description are efficiently obtained. Certain changes may be made to the components of the products without departing from the scope of the embodiments of the invention. It is intended that all matter contained in the above description, as well as is shown in the accompanying drawings shall be interpreted as illustrative only of one embodiment of the invention and not place any limitation on the scope of the invention.

What is claimed

1. A two-part, flip top, snap cap for tubes of a vial comprising
a top part comprising a circular top surface with a generally perpendicular, cylindrical outer wall, a generally perpendicular, cylindrical inner skirt containing an outer sealing surface, a desiccant chamber and an inset portion formed in an outer surface of the cylindrical outer wall,
a tamper evident ring part joined to the top part by a hinge, wherein the ring part further comprises an inset portion in an outer surface thereof that aligns with the inset portion of the top part when the cap is closed on the tube, and
breakable tabs joining the ring part to the top part of the cap when the cap is first secured onto the tube,
wherein a gap exists between the top part and the ring part except where the top part is attached to the ring part by the hinge and the breakable tabs, and wherein when the breakable tabs are broken, the cap can be opened.

2. The cap of claim 1 wherein the top surface of the top part further comprises an inset portion that is aligned with the inset portion of the outer surface of the cylindrical outer wall.

3. The cap of claim 2 wherein the inset portion of the top surface has a parabolic shape.

4. The cap of claim 1 wherein the cap does not further comprise a beak or thumb tab that extends outward from the cylindrical outer wall of the top part.

5. A vial comprising
a tube with upward extending lip, and
a two-part, flip top, snap cap for tubes of a vial comprising
a top part comprising a circular top surface with a generally perpendicular, cylindrical outer wall, a generally perpendicular, cylindrical inner skirt containing an outer sealing surface, a desiccant chamber and an inset portion formed in an outer surface of the cylindrical outer wall,
a tamper evident ring part joined to the top part by at least a hinge, wherein the ring part further comprises an inset portion in an outer surface thereof that aligns with the inset portion of the top part when the cap is closed on the tube, and
breakable tabs joining the ring part to the top part of the cap when the cap is first secured onto the tube,
wherein a gap exists between the top part and the ring part except where the top part is attached to the ring part by the hinge and the breakable tabs, and wherein when the breakable tabs are broken, the cap can be opened.

6. The vial of claim 5 wherein the upward extending lip of the tube fits securely within a gap formed in the cap.

7. The vial of claim 5 wherein the top surface of the top part further comprises an inset portion that is aligned with the inset portion of the outer surface of the cylindrical outer wall.

8. The vial of claim 7 wherein the inset portion of the top surface has a parabolic shape in the top surface.

9. The vial of claim 5 wherein the cap does not further comprise a beak or thumb tab that extends outward from the cylindrical outer wall of the top part.

10. The vial of claim 5, wherein inward facing tabs of the tamper evident ring part assist in securing the cap onto the tube of the vial.
